(19) United States
(12) Patent Application Publication
(10) Pub. No.: US 2022/0253751 A1
(43) Pub. Date: Aug. 11, 2022

(54) HUMAN IDENTIFICATION METHOD BASED ON EXPERT FEEDBACK MECHANISM

(71) Applicant: Northwestern Polytechnical University, Xi'an (CN)

(72) Inventors: Zhiwen Yu, Xi'an (CN); Qingyang Li, Xi'an (CN); Wei Xu, Xi'an (CN); Zhu Wang, Xi'an (CN); Bin Guo, Xi'an (CN)

(21) Appl. No.: 17/727,725

(22) Filed: Apr. 23, 2022

Related U.S. Application Data
(63) Continuation of application No. PCT/CN2020/110547, filed on Aug. 21, 2020.

(30) Foreign Application Priority Data
May 9, 2020 (CN) 202010386353.5

(51) Int. Cl. G06N 20/20; G06N 7/00

(52) U.S. Cl. CPC G06N 20/20; G06N 7/005

(57) ABSTRACT

The disclosure provides an identification method based on an expert feedback mechanism, in which the expert properly give a feedback to results of a static model, the model is dynamically adjusted and updated according to the feedback of the expert each time, so that identifications for similar objects can be changed from a wrong identification to a correct identification. The model can adapt to dynamic changes of the environment, so that an identification accuracy and robustness of the model under the dynamic environment are improved with an expertise. The accuracy of the identification model is improved without repeated training, which solves a problem that the accuracy of the static model decreases in the dynamic environment, raising an adaptability of the identification model to environmental changes, shortening updating time of the model and improving working efficiency of the identification application system.

### CROSS-REFERENCE TO RELATED APPLICATION(S)

This application claims priority to and the benefit of Chinese Patent Application Serial No. 202010386353.5, filed May 9, 2020, the entire disclosure of which is hereby incorporated by reference.

### TECHNICAL FIELD

The disclosure relates to a field of algorithms for human-machine cooperation and human identification, in particular to a human identification method based on an expert feedback mechanism.

### BACKGROUND

In fields of home security, finance and national defense, human identification plays a key role in ensuring people's safety and security. With rapid development of machine learning and artificial intelligence, the human identification based on biometrics (such as fingerprints, irises, brain waves) and human behavior patterns (such as gait) is very much favored for its fidelity, generality and adaptability. The fields of artificial intelligence and mobile computing have a wide range of application requirements for biometric-based identification, for example, a security system can utilize user biometrics that are difficult to copy for high-precision identification, and in a smart home environment, family members can be identified with activity characteristics (such as gait), and home control can be carried out according to needs of different members.

However, due to a limited participation of terminal users in a learning process, whose dynamic is ignored, existing identification models based on the machine learning are mostly static. Firstly, signals and data from various sources, such as wireless sensors (Wi-Fi, radar, etc.) are obtained and then relevant characteristics are extracted to represent the collected data. Finally, an identification model based on the machine learning or deep learning algorithm is constructed with these characteristics as input. Since the identification model constructed in a traditional process is usually not updated in time, it is limited in processing dynamic changes of a newly observed continuous data. In a real life, static identification methods often lead to higher false positive or false negative. For example, for a gait-based identification system, human gaits vary greatly in different circumstances. It is generally time-consuming and impractical to retain the static model to receive new characteristics that contain changes. However, if the identification model cannot be adjusted and updated effectively, it will lead to a wrong identification of human. Therefore, for participation of human (such as a doormen or an expert), a necessary calibration for the identification algorithm and a necessary correction for identification results can be carried out to avoid or reduce security risks. Therefore, it is of great practical significance to introduce an expert in artificial intelligence into the identification system, and in a process of model learning, the expert can dynamically provide a qualify feedback, thus improving robustness of the system. In this way, the system can interact with the expert and optimize its model structure. In practice, one expert is required to assist in providing a high-quality observation and an interpretation of a model output, and in some cases, the identification model requires the expert to provide a feedback for the identification results and dynamic changes of the environment, so that the model may be adjusted and optimized accordingly. Therefore, through combining the expertise in the field with a computing power of the machine, a closely coupled updating process of a human-machine cooperation model may be created, contributing to improving an accuracy and credibility of the identification and enhancing robustness of the identification system in the dynamic environment.

### SUMMARY

In order to overcome shortcomings of the prior art, a static model constructed by an existing identification method cannot adapt to a dynamically changing environment, The disclosure provides an identification method based on an expert feedback mechanism, in which the expert properly gives a feedback for results of a static model, the model is dynamically adjusted and updated according to the feedback of the expert each time, so that identifications for similar objects can be changed from a wrong identification to a correct identification. The model can adapt to dynamic changes of the environment, so that an identification accuracy and robustness of the model in a dynamic environment are improved with an expertise.

The technical schemes employed to solve the technical problems comprises following steps:

Step 1: acquiring perceptual data with a perceptual device in a perceptual data preprocess stage, performing characteristic extraction on the acquired perceptual data, and distinguishing different persons with the extracted characteristic, with an accuracy of more than 70% using random forest algorithm, with feasibility for identification;

Step 2: constructing an initial identification model that is based on a tree structure, in which division characteristics and eigenvalues of left and right subtrees of nodes on each layer of the tree are randomly selected, data of an identification target and data of other persons are randomly selected as a training set for pre-training the model, for an identification application, identifying users successfully means identifying self data as normal and other persons' data as abnormal, that is, an output resulted from inputting the self data into the model is True, and an output resulted from inputting the other persons' data into the model is False, thus a problem of identifying whether the current user is self is transformed into a two-category problem, so that the self data and other persons' data are distinguished; meanwhile each of the users has his own identification model established, in which non-self data will be identified as abnormal, thus the tree model is used as a basic model for identification.

In the tree model, firstly a depth of the tree is determined, and characteristic dimensions and eigenvalues used to divide each of the nodes are randomly selected when the model is trained, each data traverses a whole structure of the tree model and is classified into left or right subtrees according to characteristic dimensions and eigenvalues of the nodes, if the eigenvalues of the data are smaller than that of the nodes, the data will be classified into the left subtree, and if the eigenvalues of the data are larger than or equal to that of the nodes, the data will be classified into the right subtree, and so on, until the data falls on a certain leaf node, and traversing of the data ends, a preliminary training model is obtained after all of the training data have traversed; data of the same person will fall on a same node with a large probability, since the self data is more than the other persons' data, a sample density in the node where the self data is located is higher than that in other nodes, then the abnormal scores of each data are calculated for the sample density in each node according to Formula (1)-(3), the higher the score, the more likely the data is abnormal data, namely, non-self data. In order to avoid mistakes caused by contingency, the identification model established for the users is consist of plural different tree models, the data is input into each of the tree models to obtain abnormal scores of each tree, then final abnormal scores are obtained in average, the data is classified into two categories according to a relativity of the scores to a classification threshold: normal or abnormal, if the abnormal score is above the threshold, the data is abnormal, and if the abnormal score is below the threshold, the data is normal, thus distinguishing self from non-self; a calculation process of the abnormal scores is as follows.

Assuming that a certain sample data falls on a leaf node of the i-th tree, a density of the leaf node is:

$${m}_{i} = {v}_{i} \times {2}^{{h}_{i}} , \qquad ( 1 )$$

where, vᵢ is the number of samples whose history falls on the node, and hᵢ is the number of layer in the tree where the node is located, then an abnormal score yᵢ of the i-th tree is:

$${y}_{i} = 1 - {s}_{i} ( {m}_{i} ) , \qquad ( 2 )$$

where, sᵢ (mᵢ) is a cumulative distribution function of logistic distribution:

$${s}_{i} ( {m}_{i} ; {μ}_{i} , {σ}_{i} ) = \frac{1}{1 + exp \{ \frac{\sqrt{3} ▯ ( {μ}_{i} - {m}_{i} )}{π {σ}_{i}} \}} , \qquad ( 3 )$$

where, μᵢ and σᵢ respectively indicates an expected value and standard deviation of the node density mᵢ in eigenspace; assuming that the identification model is consist of “M trees”, then an overall abnormal score y of the sample data X is:

$$y = \frac{1}{M} {\sum }_{i = 0}^{M} {y}_{i} \qquad ( 4 )$$

the data of the identification target and the data of the other persons are randomly selected as the training set for model pre-training, the abnormal scores of training of the sample data are ranked in a descending order, and a classification threshold is selected, when a new sample data is classified with the identification model, if a calculated abnormal score is smaller than the classification threshold, the associated user will be identified as self, otherwise identified as non-self.

Step 3: performing identification with the initial identification model, and sending the identification result to the expert for judgment at a random probability for each identification, in which the expert judges whether the identification result is correct, if the identification result is correct, then the expert feedback is positive, and if the identification result is incorrect, then the expert feedback is negative;

Step 4: adjusting and updating the identification model according to the expert feedback in four ways including increasing the node density mᵢ, decreasing the node density mᵢ, downward growing the tree, and upward incorporating the sub-tree; for the leaf node where the data falls after traversing the tree structure, constructing a local node likelihood to measure rationality of the current tree structure, the local node likelihood being defined as:

$${Likelihood}^{r} = {\prod }_{{j = 1}^{}}^{{a}_{i}} P ( {t}_{j} = 1 ; {m}_{i} ) {\prod }_{l = 1}^{{n}_{i}} P ( {t}_{l} = 0 ; {m}_{i} ) ; \qquad ( 5 )$$

and a current sample likelihood being defined as

$${Likelihood}^{x} = {{y}^{t} ( 1 - y )}^{1 - t} \qquad ( 6 )$$

where, Likelihood^{r} and Likehhood^{x} respectively indicates the local node likelihood and current sample likelihood; P(t=1; mᵢ)=yᵢ is a probability of the abnormal score equivalent to be identified as abnormal;

$${\prod }_{{j = 1}^{}}^{{a}_{i}} P ( {t}_{j} = 1 ; {m}_{i} ) and {{\prod }_{l = 1}}^{{n}_{i}} P ( {t}_{l} = 0 ; {m}_{i} )$$

respectively indicates an actual joint abnormal probability of samples with historical abnormal feedback and normal feedback in the leaf node; aᵢ and nᵢ respectively indicates the number of the samples with historical abnormal feedback and normal feedback; and t indicates an identification result, there are only two results, t=1 (abnormal, non-self) and t=0 (normal, self);

taking logarithm for Likelihood^{r} and Likelihood^{x} respectively to obtain L^{r} and L^{x}:

$${L}^{r} = {a}_{i} ln [ 1 - {s}_{i} ( {m}_{i} ) ] + {n}_{i} ln s ( {m}_{i} ) \qquad ( 7 )$$

$${L}^{x} = t ln y + ( 1 - t ) ln ( 1 - y ) \qquad ( 8 )$$

due to mᵢ is the only variable in formula (7) and (8), both L^{r} and L^{x} being derivative of mᵢ according to the maximum likelihood principle, resulting in:

$${r}_{i} = \frac{\partial {L}^{r}}{\partial {m}_{i}} = \frac{\sqrt{3}}{π {σ}_{i}} [ {n}_{i} - ( {a}_{i} + {n}_{i} ) {s}_{i} ( {m}_{i} ) ] \qquad ( 9 )$$

$${g}_{i} = \frac{\partial {L}^{x}}{\partial {m}_{i}} = \frac{\sqrt{3}}{M π {σ}_{i}} \frac{y - t}{y ( 1 - y )} {s}_{i} ( {m}_{i} ) [ 1 - {s}_{i} ( {m}_{i} ) ] \qquad ( 10 )$$

then determining a final adjustment strategy according to whether the value of rᵢ and gᵢ are positive or negative, in which

a. If both rᵢ and gᵢ are positive, it is proved that mᵢ should be increased to make the joint function more optimal, if a brother node of the leaf node has no historical negative feedback, then the left and right nodes combined upward, if the brother node of the leaf node has historical negative feedback, then the node density mᵢ is increased;

b. If both rᵢ and gᵢ are negative, it is proved that mᵢ should be decreased to make the joint function more optimal, if a depth of the current tree model has not reached a maximum depth, then the tree is downward grown so that the abnormal data will be more dispersed, if the depth of the current tree model has reached the maximum depth and the tree cannot be grown downward, then the node density mᵢ is decreased;

c. If one of rᵢ and gᵢ is positive and the other of them is negative, it is necessary to grow the tree downward, through setting a characteristic dimension and eigenvalue for node division, normal and abnormal samples are classified into left and right sub-nodes, so as to be classified into different nodes;

Step 5: performing the adjustment process in step 4 each time when the feedback data is generated, and continuing a next identification with the adjusted and updated identification model, then repeating step 3 and step 4 until the model reaching a required accuracy.

In the step 2, the data of the identification target and the data of the other persons are randomly selected as the training set for model pre-training, a ratio of the identification target data to the other persons' data is 9:1 in the training set, that is, there are 10% of abnormal data, the abnormal scores of the training samples are ranked in a descending order, and the top 10% highest abnormal scores are extracted in which a minimum abnormal score is the classification threshold.

In the step 3, the current identification result is given to the expert for feedback with a probability of 20%.

The method has beneficial effects that by combining the identification model based on a tree structure with the expert feedback and adjusting a structure of the model in real time according to the expert feedback, the accuracy of the identification model is improved without repeated training, which solves a problem that the accuracy of the static model decreases in the dynamic environment, raising an adaptability of the identification model to environmental changes, shortening updating time of the model and improving working efficiency of the identification application system.

### BRIEF DESCRIPTION OF THE DRAWINGS

FIG. 1 is a flow chart of an identification method based on an expert feedback mechanism.

### DETAILED DESCRIPTION

The disclosure will be further explained with reference to the figure and embodiments.

The method includes following steps.

In Step 1: characteristic extraction is performed on an acquired perceptual signal to ensure that the extracted characteristic facilitates distinguishing different persons, with feasibility for identification;

In Step 2, an initial identification model is constructed which is based on a tree structure. Division characteristics and eigenvalues of left and right subtrees of nodes of each layer of the tree are randomly selected, and data of an identification target and other persons' data are randomly selected as a training set for pre-training the model, so as to obtain an initial identification model.

In Step 3, identification is performed with the initial identification model, and an identification result is sent to an expert for judgment with a probability for each identification, then the expert judges whether the identification result is correct with his expertise, if the result is correct, then the expert feedback is positive, and if the result is wrong, then the expert feedback is negative.

In Step 4, the results of the expert feedback are inputted into the identification model, and the an adaptive adjustment is made to the model according to the feedback, the tree structure or attributes of tree knots and nodes are changed, ensuring that the model can strengthen a correct part and correct a wrong part, thus improving an overall accuracy with the expertise.

In Step 5, identification is made with the updated identification model, steps 3 and 4 are repeated, thus dynamically improving the accuracy of the identification model in an iterative cycle.

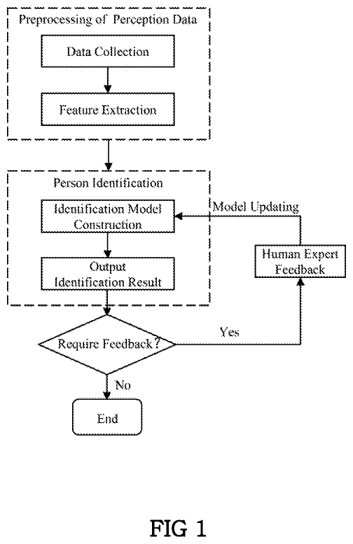

As shown in FIG. 1, a process of the identification method is as follows.

In Step 1, perceptual data is acquire with a perceptual device (such as wearable devices, passive perceptual devices) in a perceptual data preprocess stage, characteristic extraction is performed on the acquired perceptual data, and different persons are distinguished with the extracted characteristic, with an accuracy of more than 70% using random forest algorithm with feasibility for identification. The present disclosure is not limited to any sensing method, and all sensing signals (including but not limited to WiFi and radar) that can be used for identification can be identified with the model of the present disclosure after biometric extraction, for example, gait characteristics that extracted according to an influence of pedestrians on WiFi signals are used for identification since different persons have different gait characteristics. On the premise that useful data and characteristics have been obtained, the disclosure lies in how to use the expert feedback to dynamically update the identification model and improve the identification accuracy. In a practical application, the data acquisition method and characteristic extraction method can be changed according to application needs.

In Step 2: an initial identification model is constructed which is based on a tree structure, in which division characteristics and eigenvalues of left and right subtrees of nodes on each layer of the tree are randomly selected, data of an identification target and data of other persons are randomly selected as a training set for pre-training the model, for an identification application, identifying users successfully means identifying self data as normal and other persons' data as abnormal, that is, an output resulted from inputting the self data into the model is True, and an output resulted from inputting the other persons' data into the model is False, thus a problem of identifying whether the current user is self is transformed into a two-category problem so that the self data and other persons' data are distinguished. Meanwhile, each of the users has his own identification model established, in which non-self data will be identified as abnormal, thus the tree model is used as a basic model for identification.

In the tree model, firstly a depth of the tree is determined, and characteristic dimensions and eigenvalues used to divide each of the nodes are randomly selected when the model is trained, each data traverses a whole structure of the tree model and is classified into left or right subtrees according to characteristic dimensions and eigenvalues of the nodes, if the eigenvalues of the data are smaller than that of the nodes, the data will be classified into the left subtree, and if the eigenvalues of the data are larger than or equal to that of the nodes, the data will be classified into the right subtree, and so on, until the data falls on a certain leaf node, and traversing of the data ends, a preliminary training model is obtained after all of the training data have traversed; data of the same person will fall on a same node with a large probability, since the self data is more than the other persons' data, a sample density in the node where the self data is located is higher than that in other nodes, then the abnormal scores of each data are calculated for the sample density in each node according to Formula (1)-(3), the higher the score, the more likely the data is abnormal data, namely, non-self data. In order to avoid mistakes caused by contingency, the identification model established for the users is consist of plural different tree models, the data is input into each of the tree models to obtain abnormal scores of each tree, then final abnormal scores are obtained in average, the data is classified into two categories according to a relativity of the scores to a classification threshold: normal or abnormal, if the abnormal score is above the threshold, the data is abnormal, and if the abnormal score is below the threshold, the data is normal, thus distinguishing self from non-self; a calculation process of the abnormal scores is as follows.

Assuming that a certain sample data X falls on a leaf node of the i-th tree, a density mᵢ of the leaf node is:

$${m}_{i} = {v}_{i} \times {2}^{{h}_{i}} \qquad ( 1 )$$

where, vᵢ is the number of samples whose history falls on the node, and hᵢ is the number of layer in the tree where the node is located, then an abnormal score yᵢ of the i-th tree is:

$${y}_{i} = 1 - {s}_{i} ( {m}_{i} ) \qquad ( 2 )$$

where, sᵢ (mᵢ) is a cumulative distribution function of logistic distribution:

$${s}_{i} ( {m}_{i} ; {μ}_{i} , {σ}_{i} ) = \frac{1}{1 + exp \{ \frac{\sqrt{3} ▯ ( {μ}_{i} - {m}_{i} )}{π {σ}_{i}} \}} \qquad ( 3 )$$

where, μᵢ and σᵢ respectively indicates an expected value and standard deviation of the node density mᵢ in eigenspace; assuming that the identification model is consist of “M trees”, then an overall abnormal score y of the sample data X is:

$$y = \frac{1}{M} {\sum }_{i = 0}^{M} {y}_{i} \qquad ( 4 )$$

The data of the identification target and the data of the other persons are randomly selected as the training set for model pre-training, a ratio of the identification target data to the other persons' data is 9:1 in the training set, that is, there are 10% of abnormal data, the abnormal scores of the training samples are ranked in a descending order, and the top 10% highest abnormal scores are extracted in which a minimum abnormal score is the classification threshold. When a new sample data is classified with the identification model, if a calculated abnormal score is smaller than the classification threshold, the associated user will be identified as self, otherwise identified as non-self.

In Step 3, identification is performed with the initial identification model, and an identification result is sent to an expert for judgment with a probability for each identification, then the expert judges whether the identification result is correct with his expertise, if the result is correct, then the expert feedback is positive, and if the result is wrong, then the expert feedback is negative. In the present disclosure, the feedback provided by the expert is correct by default. Due to a need to reduce work of the expert as much as possible, the identification results are given to the expert for feedback with a probability of 20%, it is not necessary for the expert to feedback for all of the identification results.

In Step 4, the identification model is adjusted and updated according to the expert feedback in four ways including increasing the node density mᵢ decreasing the node density mᵢ downward growing the tree, and upward incorporating the sub-tree.

Specifically, since one identification model is consist of plural trees, and each sample data is located in different leaf nodes in different trees, the model is updated concerning a single local node and the whole classification model. Obviously, if the accuracy of the model is high enough, the nodes with higher abnormal scores contain more historical abnormal feedback, whereas the nodes with lower abnormal scores contain more historical normal feedback. The resulting abnormal score is between 0 and 1, which is regarded as a possibility that the sample is abnormal. Therefore, from a local perspective, a local node likelihood is constructed to measure a rationality of the current tree structure, and from a whole perspective of the model, the current sample likelihood is used to measure rationality of an adjustment method of the model; the local node likelihood and current sample likelihood are defined as:

$$\begin{matrix}{Likelihood}^{r} = {\prod }_{j = 1}^{{a}_{i}} P ( {t}_{j} = 1 ; {m}_{i} ) {\prod }_{l = 1}^{{n}_{i}} P ( {t}_{l} = 0 ; {m}_{i} ) & ( 5 ) \\ {Likelihood}^{x} = {{y}^{t} ( 1 - y )}^{1 - t} & ( 6 )\end{matrix}$$

where, Likelihood^{r} and Likelihood^{x} respectively indicates the local node likelihood and current sample likelihood; P(t=1; mᵢ)=yᵢ is a probability of the abnormal score equivalent to be identified as abnormal;

$${\prod }_{j = 1}^{{a}_{i}} P ( {t}_{j} = 1 ; {m}_{i} ) and {\prod }_{l = 1}^{{n}_{i}} P ( {t}_{l} = 0 ; {m}_{i} )$$

respectively indicates an actual joint abnormal probability of samples with historical abnormal feedback and normal feedback in the leaf node; aᵢ and nᵢ respectively indicates the number of the samples with historical abnormal feedback and normal feedback; and indicates an identification result, there are only two results, t=1 (abnormal, non-self) and t=0 (normal, self).

Logarithm is taked for Likelihood^{x} and Likelihood^{x} respectively to obtain L^{r} and L^{x}:

$${L}^{r} = {a}_{i} ln [ 1 - {s}_{i} ( {m}_{i} ) ] + {n}_{i} ln s ( {m}_{i} ) \qquad ( 7 )$$

$${L}^{x} = t ln y + ( 1 - t ) ln ( 1 - y ) \qquad ( 8 )$$

In order to improve performance of the identification model, the model should be adjusted to adapt to the existing feedback. A logarithm likelyhood function for the local part and the whole has been constructed by formula (7) and (8), the decision is made by joint maximization of two objective functions L^{r} and L^{x} following the principle of maximum likelihood. Due to mᵢ is the only variable in formula (7) and (8), both L^{r} and L^{x} are derivative of mᵢ according to the maximum likelihood principle, resulting in:

$$\begin{matrix}{r}_{i} = \frac{\partial {L}^{r}}{\partial {m}_{i}} = \frac{\sqrt{3}}{π {σ}_{i}} [ {n}_{i} - ( {a}_{i} + {n}_{i} ) {s}_{i} ( {m}_{i} ) ] & ( 9 ) \\ {g}_{i} = \frac{\partial {L}^{x}}{\partial {m}_{i}} = \frac{\sqrt{3}}{M π {σ}_{i}} \frac{y - t}{y ( 1 - y )} {s}_{i} ( {m}_{i} ) [ 1 - {s}_{i} ( {m}_{i} ) ] & ( 10 )\end{matrix}$$

Then a final adjustment strategy is determined according to whether the value of rᵢ and gᵢ are positive or negative, in which

a. If both rᵢ and gᵢ are positive, it is proved that mᵢ should be increased to make the joint function more optimal, if a brother node of the leaf node has no historical negative feedback, then the left and right nodes combined upward, if the brother node of the leaf node has historical negative feedback, then the node density mᵢ is increased;

b. If both rᵢ and gᵢ are negative, it is proved that mᵢ should be decreased to make the joint function more optimal, if a depth of the current tree model has not reached a maximum depth, then the tree is downward grown so that the abnormal data will be more dispersed, if the depth of the current tree model has reached the maximum depth and the tree cannot be grown downward, then the node density mᵢ is decreased;

c. If one of rᵢ and gᵢ is positive and the other of them is negative, it is necessary to grow the tree downward, through setting a characteristic dimension and eigenvalue for node division, normal and abnormal samples are classified into left and right sub-nodes, so as to be classified into different nodes.

In Step 5: the adjustment process in step 4 is performed each time when the feedback data is generated, and a next identification is continued with the adjusted and updated identification model, then step 3 and step 4 are repeated until the model reaching a required accuracy.

In view of the limitation that a static model constructed by an existing identification method cannot adapt to the dynamically changing environment, the disclosure provides an identification method based on an expert feedback mechanism, in which the expert properly gives a feedback for results of a static model, the model is dynamically adjusted and updated according to the feedback of the expert each time, so that identifications for similar objects can be changed from a wrong identification to a correct identification. The model can adapt to dynamic changes of the environment, so that an identification accuracy and robustness of the model in a dynamic environment are improved with an expertise.

What is claimed is:

1. An identification method based on an expert feedback mechanism, comprising:
Step 1: acquiring perceptual data with a perceptual device in a perceptual data preprocess stage, performing characteristic extraction on the acquired perceptual data, and distinguishing different persons with the extracted characteristic, with an accuracy of more than 70% using random forest algorithm with feasibility for identification;
Step 2: constructing an initial identification model that is based on a tree structure, in which division characteristics and eigenvalues of left and right subtrees of nodes on each layer of the tree are randomly selected, data of an identification target and data of other persons are randomly selected as a training set for pre-training the model, for an identification application, identifying users successfully means identifying self data as normal and other persons' data as abnormal, that is, an output resulted from inputting the self data into the model is True, and an output resulted from inputting the other persons' data into the model is False, thus a problem of identifying whether the current user is self is transformed into a two-category problem so that the self data and other persons' data are distinguished; meanwhile each of the users has his own identification model established, in which non-self data will be identified as abnormal, thus the tree model is used as a basic model for identification;
in the tree model, firstly a depth of the tree is determined, and characteristic dimensions and eigenvalues used to divide each of the nodes are randomly selected when the model is trained, each data traverses a whole structure of the tree model and is classified into left or right subtrees according to characteristic dimensions and eigenvalues of the nodes, if the eigenvalues of the data are smaller than that of the nodes, the data will be classified into the left subtree, and if the eigenvalues of the data are larger than or equal to that of the nodes, the data will be classified into the right subtree, and so on, until the data falls on a certain leaf node, and traversing of the data ends, a preliminary training model is obtained after all of the training data have traversed; data of the same person will fall on a same node with a large probability, since the self data is more than the other persons' data, a sample density in the node where the self data is located is higher than that in other nodes, then the abnormal scores of each data are calculated for the sample density in each node according to Formula (1)-(3), the higher the score, the more likely the data is abnormal data, namely, non-self data; in order to avoid mistakes caused by contingency, the identification model established for the users is consist of plural different tree models, the data is input into each of the tree models to obtain abnormal scores of each tree, then final abnormal scores are obtained in average, the data is classified into two categories according to a relativity of the scores to a classification threshold: normal or abnormal, if the abnormal score is above the threshold, the data is abnormal, and if the abnormal score is below the threshold, the data is normal, thus distinguishing self from non-self; a calculation process of the abnormal scores is as follows,
assuming that a certain sample data falls on a leaf node of the i-th tree, a density of the leaf node is:
$${m}_{i} = {v}_{i} \times {2}^{{h}_{i}} , \qquad ( 1 )$$
wherein, is the number of samples whose history falls on the node, and is the number of layer in the tree where the node is located, then an abnormal score of the i-th tree is:
$${y}_{i} = 1 - {s}_{i} ( {m}_{i} ) , \qquad ( 2 )$$
wherein, sᵢ (mᵢ) is a cumulative distribution function of logistic distribution:
$${s}_{i} ( {m}_{i} ; {μ}_{i} , {σ}_{i} ) = \frac{1}{1 + exp \{ \frac{\sqrt{3} • ( {μ}_{i} - {m}_{i} )}{π {σ}_{i}} \}} , \qquad ( 3 )$$
wherein, μᵢ and σᵢ respectively indicates an expected value and standard deviation of the node density mᵢ in eigenspace; assuming that the identification model is consist of “M trees”, then an overall abnormal score y of the sample data X is:
$$y = \frac{1}{M} {\sum }_{i = 0}^{M} {y}_{i} \qquad ( 4 )$$
the data of the identification target and the data of the other persons are randomly selected as the training set for model pre-training, the abnormal scores of training of the sample data are ranked in a descending order, and a classification threshold is selected, when a new sample data is classified with the identification model, if a calculated abnormal score is smaller than the classification threshold, the associated user will be identified as self, otherwise identified as non-self;
Step 3: performing identification with the initial identification model, and sending the identification result to the expert for judgment at a random probability for each identification, in which the expert judges whether the identification result is correct, if the identification result is correct, then the expert feedback is positive, and if the identification result is incorrect, then the expert feedback is negative;
Step 4: adjusting and updating the identification model according to the expert feedback in four ways including increasing the node density mᵢ, decreasing the node density mᵢ, downward growing the tree, and upward incorporating the sub-tree; for the leaf node where the data falls after traversing the tree structure, constructing a local node likelihood to measure rationality of the current tree structure, the local node likelihood being defined as:
$${Likelihood}^{r} = {\prod }_{j = 1}^{{a}_{i}} P ( {t}_{j} = 1 ; {m}_{i} ) {\prod }_{l = 1}^{{n}_{i}} P ( {t}_{l} = 0 ; {m}_{i} ) ; \qquad ( 5 )$$
and a current sample likelihood being defined as
$${Likelihood}^{x} = {{y}^{t} ( 1 - y )}^{1 - t} \qquad ( 6 )$$
wherein, Likelihood^{r} and Likelihood^{x} respectively indicates the local node likelihood and current sample likelihood; P(t=1; mᵢ)=yᵢs a probability of the abnormal score equivalent to be identified as abnormal;
$${\prod }_{j = 1}^{{a}_{i}} P ( {t}_{j} = 1 ; {m}_{i} ) and {\prod }_{l = 1}^{{n}_{i}} P ( {t}_{l} = 0 ; {m}_{i} )$$
respectively indicates an actual joint abnormal probability of samples with historical abnormal feedback and normal feedback in the leaf node; aᵢ and nᵢ respectively indicates the number of the samples with historical abnormal feedback and normal feedback; and t indicates an identification result, there are only two results, t=1 (abnormal, non-self) and t=0 (normal, self);
taking logarithm for Likelihood^{r} and Likelihood^{x} respectively to obtain L^{r} and L^{x}:
$$\begin{matrix}{L}^{r} = {a}_{i} ln [ 1 - {s}_{i} ( {m}_{i} ) ] + {n}_{i} ln s ( {m}_{j} ) & ( 7 ) \\ {L}^{ x} = t ln y + ( 1 - t ) ln ( 1 - y ) & ( 8 )\end{matrix}$$
due to mᵢ is the only variable in formula (7) and (8), both L^{r} and L^{x} being derivative of mᵢ according to the maximum likelihood principle, resulting in:
$$\begin{matrix}{r}_{i} = \frac{\partial {L}^{r}}{\partial {m}_{i}} = \frac{\sqrt{3}}{π {σ}_{i}} [ {n}_{i} - ( {a}_{i} + {n}_{i} ) {s}_{i} ( {m}_{i} ) ] & ( 9 ) \\ {g}_{i} = \frac{\partial {L}^{x}}{\partial {m}_{i}} = \frac{\sqrt{3}}{M π {σ}_{i}} \frac{y - t}{y ( 1 - y )} {s}_{i} ( {m}_{i} ) [ 1 - {s}_{i} ( {m}_{i} ) ] & ( 10 )\end{matrix}$$
then determining a final adjustment strategy according to whether the value of rᵢ and g₁ are positive or negative, in which
a. If both rᵢ and gᵢ are positive, it is proved that mᵢ should be increased to make the joint function more optimal, if a brother node of the leaf node has no historical negative feedback, then the left and right nodes combined upward, if the brother node of the leaf node has historical negative feedback, then the node density mᵢ is increased;
b. If both rᵢ and gᵢ are negative, it is proved that mᵢ should be decreased to make the joint function more optimal, if a depth of the current tree model has not reached a maximum depth, then the tree is downward grown so that the abnormal data will be more dispersed, if the depth of the current tree model has reached the maximum depth and the tree cannot be grown downward, then the node density mᵢ is decreased;
c. If one of rᵢ and gᵢ is positive and the other of them is negative, it is necessary to grow the tree downward, through setting a characteristic dimension and eigenvalue for node division, normal and abnormal samples are classified into left and right sub-nodes, so as to be classified into different nodes;
Step 5: performing the adjustment process in step 4 each time when the feedback data is generated, and continuing a next identification with the adjusted and updated identification model, then repeating step 3 and step 4 until the model reaching a required accuracy.

2. The identification method according to claim 1, wherein
In the step 2, the data of the identification target and the data of the other persons are randomly selected as the training set for model pre-training, a ratio of the identification target data to the other persons' data is 9:1 in the training set, that is, there are 10% of abnormal data, the abnormal scores of the training samples are ranked in a descending order, and the top 10% highest abnormal scores are extracted in which a minimum abnormal score is the classification threshold.

3. The identification method according to claim 1, wherein
In the step 3, the current identification result is given to the expert for feedback with a probability of 20%.
